(19) United States
(12) Patent Application Publication
(10) Pub. No.: US 2005/0062932 A1
(43) Pub. Date: Mar. 24, 2005

(54) Process of producing plastic lens and plastic lens

(75) Inventors: Masahisa Kosaka, Tokyo (JP); Tomoaki Yanagida, Tokyo (JP); Yoshitaka Kitahara, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Hoya Corporation

(21) Appl. No.: 10/946,189

(22) Filed: Sep. 22, 2004

(30) Foreign Application Priority Data
Sep. 22, 2003 (JP) 2003-330285

(51) Int. Cl. B29D 11/00

(52) U.S. Cl. 351/159; 264/1.1

(57) ABSTRACT

A process of producing a plastic lens having a high refractive index, a high Abbe's number and good mechanical strength and a plastic lens obtained by that process. A process of producing a plastic lens including a step of polymerizing a mixture of (1) a prepolymer obtained by mixing and reacting from 0.1% by weight to 10% by weight, based on the whole amount of the mixture, of sulfur and an epithio group-containing compound, (2) a polyisocyanate compound, and (3) a polythiol compound; and a plastic lens obtained by this process.

### CROSS-REFERENCE TO RELATED APPLICATION

Japanese Application No. 2003-330285 filed Sep. 22, 2003, the disclosure of which is expressly incorporated by reference herein in its entirety.

### DESCRIPTION OF THE INVENTION

1. Field of the Invention

The present invention relates to a process of producing a plastic lens having a high refractive index, a high Abbe's number and a high mechanical strength, which is suitably used for spectacle plastic lenses and to a plastic lens obtained by that process.

2. Background of the Invention

In the market of plastic lenses, especially in the market of spectacle plastic lenses, plastic lenses having a high refractive index and a high Abbe's number are demanded. An advantage of high-refractive index plastic lenses resides in the matter that it is possible to prepare a lens even having a strong refractive power such that its central thickness or surrounding thickness is thin. Also, in recent years, two-point spectacles free from a lens frame are popular. In the case where a two-point spectacle is fabricated using high-refractive index plastic lenses, high-refractive index plastic lenses not only having a thin central thickness or surrounding thickness as compared with low-refractive index plastic lenses but also having a more improved mechanical strength and the like are demanded.

As examples of such a high-refractive index plastic lens, a plastic lens having a refractive index of about 1.70 and constituted of a polyisocyanate compound, a polythiol compound and an epithio group-containing compound is disclosed in JP-A-2001-330701. Though the plastic lens disclosed in this document attains characteristics such as high refractive index, high Abbe's number, and good mechanical strength, a plastic lens having a further good mechanical strength is needed.

Plastic lenses obtained by polymerizing and curing an optical material composition containing a mixture of a sulfur-containing compound and an inorganic compound containing a sulfur atom and/or a selenium atom are disclosed in JP-A-2001-2783 and JP-A-2001-2933. According to the processes of producing a lens disclosed in these documents, the resulting lenses are insufficient in transparency and are subject to yellowing. A plastic lens having a further good mechanical strength is needed.

### SUMMARY OF THE INVENTION

The invention relates to a process of producing a plastic lens having a high refractive index, a high Abbe's number and improved mechanical strength and a plastic lens obtained by that process. It has been found that such a lens can be made by following a prepolymerization measure. Specifically, the invention provides a process of producing a plastic lens including a step of polymerizing lens raw materials as a mixture of (1) a prepolymer obtained by mixing and reacting from 0.1% by weight to 10% by weight, based on the whole amount of the lens raw materials, of sulfur and an epithio group-containing compound, (2) a polyisocyanate compound, and (3) a polythiol compound; and a plastic lens obtained by this production process.

By following this process, a plastic lens having a high refractive index, a high Abbe's number and a high mechanical strength is obtained.

### DESCRIPTION OF EMBODIMENTS

The process of producing a plastic lens according to the invention includes a step of polymerizing lens raw materials as a mixture of (1) a prepolymer obtained by mixing and reacting from 0.1% by weight to 10% by weight, based on the whole amount of the lens raw materials, of sulfur and an epithio group-containing compound, (2) a polyisocyanate compound, and (3) a polythiol compound. In the invention, as the step of producing the prepolymer (1), a mixed solution obtained by mixing and dissolving sulfur in an epithio group-containing compound is subjected to reaction of the epithio group-containing compound and sulfur at a reaction temperature, for example, at a temperature in the range of from 30 to 80° C., to obtain a prepolymer.

In the reaction, a proper amount of a vulcanization accelerator such as imidazole based vulcanization accelerators, for example, 2-mercapto-N-methylimidazole, imidazole, N-methylimidazole, 2-methylimidazole, 4-methylimidazole, N-ethylimidazole, 2-ethylimidazole, 4-ethylimidazole, N-butylimidazole, 2-butylimidazole, 4-butylimidazole, N-phenylimidazole, 2-phenylimidazole, N-benzylimidazole, 2-benzylimidzole, 2-mercaptoimidazole, and 2-mercaptobenzimidazole; thiuram based vulcanization accelerators, for example, tetramethylthiuram disulfide and tetramethylthiuram monosulfide; and guanizine based vulcanization accelerators, for example, diphenylguanizine and di-o-tolylguanizine, may be used.

The prepolymerization reaction of the epithio group-containing compound and sulfur may be carried out in a nitrogen atmosphere, a vacuum atmosphere, or an atmospheric environment. A suitable process for obtaining a lens having very excellent colorless transparency is to carry out the reaction with stirring at a temperature in the range of from 30 to 80° C. for one hour to 24 hours.

The stop point of the prepolymerization reaction cannot be unequivocally defined because the transparency of an ultimately obtained lens varies depending upon the kinds and amounts of a polyisocyanate compound and a polythiol compound to be added later. However, as a method of determining the stop point of the prepolymerization reaction, for example, prepolymerization reaction is carried out with the raw materials of the epithio group-containing compound and sulfur, and prepolymers are taken out at a plurality of points during that step such that the refractive index of the prepolymer differs stepwise. A refractive index of a prepolymer can be defined as the stop point under the following condition. The stop point is when each prepolymer is cooled to the vicinity of room temperature, sulfur is not again deposited, and transparency is obtained in the ultimate lens obtained by adding lens ingredients that include a polyisocyanate compound and a polythiol compound.

In this way, it is desired that at the time when the refractive index of the prepolymer rises to the stop point, heating is finished, and the prepolymer is rapidly cooled to the vicinity of room temperature. In that case, for the sake of sufficiently stopping the reaction, the reaction may be stopped by the addition of a proper amount of a reaction stopping auxiliary such as acidic phosphoric acid esters and dimethyltin dichloride at the time of completion.

The viscosity of the prepolymer at the stop point cannot be unequivocally defined because it varies depending upon the addition concentrations of the epithio group-containing compound and sulfur to be used. However, the viscosity of the prepolymer may be selected to be not more than 1 Pa·s (at 25° C.) to facilitate a mixing operation with the lens raw materials to be added later.

In the invention, from the viewpoint of obtaining a lens having especially good transparency, the content of sulfur to be used as the raw material of the prepolymer (1) is from 0.1% by weight to 10% by weight, or from 0.3% by weight to 6% by weight, or from 0.3% by weight to 5% by weight based on the whole amount of the lens raw materials.

Also, from the viewpoint of making coloration of the resulting plastic lens small, the foregoing sulfur may be sulfur from which impurities having a boiling point of not higher than 120° C. are eliminated and which has a purity of 98% by weight or more.

A method of eliminating impurities having a boiling point of not higher than 120° C. is not particularly limited. However, examples thereof include a method of heating sulfur at atmospheric pressure or in vacuo to eliminate impurities, a method of sublimating sulfur to undergo recrystallization, and a method of heating and melting sulfur to undergo recrystallization.

In the invention, the epithio group-containing compound used above in (1) may be called an episulfide based monomer. Specific examples of this monomer include alicyclic skeleton-containing episulfide compounds, for example, 1,3- and 1,4-bis(β-epithiopropylthio)cyclohexanes, 1,3- and 1,4-bis(β-epithiopropylthiomethyl)cyclohexanes, bis[4-(β-epi-thiopropylthio)cyclohexyl]methane, 2,2-bis[4-(β-epithiopropylthio)cyclohexyl]propane, bis[4-(β-epi-thiopropylthio)cyclohexyl]sulfide, and 1,3- and 1,4-bis(β-epithiopropyl)cyclohexanes; aromatic skeleton-containing episulfide compounds, for example, 1,3- and 1,4-bis(β-epithiopropylthio)benzenes, 1,3- and 1,4-bis(β-epithiopropylthiomethyl)benzenes, bis[4-(β-epithiopropylthio)-phenyl]methane, 2,2-bis[4-(β-epithiopropylthio)phenyl]propane, bis[4-(β-epithiopropylthio)phenyl]sulfide, bis[4-(β-epithiopropylthio)phenyl]sulfide, 4,4-bis(β-epithiopropylthio)biphenyl, and 1,3- and 1,4-bis(β-epithio-propyl)benzenes; dithiane ring skeleton-containing episulfide compounds, for example, 2,5-bis(β-epithiopropylthiomethyl)-1,4-dithiane, 2,5-bis(β-epithiopropylthioethylthiomethyl)-1,4-dithiane, 2,5-bis(β-epithiopropylthioethyl)-1,4,-dithiane, 2,3,5-tri(β-epithiopropylthioethyl)-1,4-dithiane, and 2,5-bis(β-epithiopropyl)-1,4-dithiane; and aliphatic skeleton-containing episulfide compounds, for example, 2-(2-β-epithiopropylthioethylthio)-1,3-bis(β-epithiopropylthio)propane, 1,2-bis[(2-β-epithiopropylthioethyl)thio]-3-(β-epithio-propylthio)propane, tetrakis(β-epithiopropylthiomethyl)methane, 1,1,1-tris(β-epithiopropylthiomethyl)propane, bis(β-epithiopropyl)sulfide, bis(β-epithiopropyl)disulfide, bis(β-epithiopropyl)ether, bis(β-epithiopropyl)methane, 1,2-bis(β-epithiopropyl)ethane, and 1,3-bis(β-epithiopropyl)propane.

Of these epithio group-containing compounds, bis(β-epithiopropyl)sulfide, bis(β-epithiopropyl)disulfide, bis(β-epithiopropyl)ether, bis(β-epithiopropyl)methane, 1,2-bis(β-epithiopropyl)ethane, 1,3-bis(β-epithiopropyl)propane, 2,5-bis(β-epithiopropyl)-1,4-dithiane, 1,3- and 1,4-bis(β-epithiopropyl)cyclohexanes, 1,3- and 1,4-bis(β-epithiopropyl)benzenes, bis[4-(β-epithiopropylthio)phenyl]sulfide, and bis[4-(β-epithiopropylthio)cyclohexyl]-sulfide are preferable. For an application to high refractive index lenses, bis(β-epithiopropyl)sulfide, bis(β-epithiopropyl)disulfide, and 2,5-bis(β-epithiopropyl)-1,4-dithiane may be used as the epithio group-containing compound.

Incidentally, epithio group-containing compounds may be used singly or in admixture.

In the invention, the total sum of the polyisocyanate compound (2) and the polythiol compound (3) may be from 3% by weight to 50% by weight, or from 10% by weight to 40% by weight, and or from 20% by weight to 40% by weight based on the whole amount of the lens raw materials described above in (1) to (3) from the viewpoint of obtaining a plastic lens having good mechanical characteristics and high refractive index.

Also, a proportion of the polyisocyanate compound (2) to the polythiol compound (3) may be in the range of 1.0 or more, or from 1.0 to 5.0, or from 1.1 to 2.0 in terms of a molar ratio of —SH group/-NCO group from the viewpoint of obtaining a colorless plastic lens having good mechanical characteristics and high transparency. Such a mixing proportion does not coincide with the description of the foregoing JP-A-2001-330701 filed by the same applicant. But, it is considered that the reason resides in the matter that the content of sulfur to be added to the epithio group-containing compound is defined to be from 0.1% by weight to 10% by weight based on the whole amount of the lens raw materials.

In the invention, it is possible to add the polyisocyanate compound (2) and the polythiol compound (3) without being subjected to prepolymerization in advance. It is considered that even when these compounds are not subjected to prepolymerization, by defining the content of sulfur to be added to the epithio group-containing compound to be from 0.1% by weight to 10% by weight based on the whole amount of the lens raw materials and synthesizing a prepolymer of the epithio group-containing compound and sulfur, the sulfur is reacted, whereby sulfur as a cause for opacity can be consumed. Also, for the sake of making the refractive index of the resulting plastic lens high as far as possible, it is preferred to add sulfur in an amount as large as possible. However, in the invention, by defining the content of sulfur to be not more than 10% by weight based on the whole amount of the lens raw materials, even when the polyisocyanate compound and the polythiol compound are added without being subjected to prepolymerization, the resulting plastic lens does not cause cloudiness, the sulfur is not required to excessively react with the epithio compound, and the viscosity does not become high, and therefore, its handling is easy.

Also, in the invention, it is possible to produce the desired plastic lens by reacting the polyisocyanate compound (2) and the polythiol compound (3) in advance to form a urethane prepolymer. However, when the raw materials having been not subjected to prepolymerization are used, the viscosity is low, subsequent operations such as mixing operation, deaeration operation, defoaming step during and after pouring into a molding die are easy, and it is easy to introduce large amounts of the polyisocyanate compound and the polythiol compound.

Examples of the polyisocyanate compound (2) that is used in the invention include polyisocyanates containing at least one aromatic ring, such as xylylene diisocyanate, 3,3′-dichlorodiphenyl-4,4′-diisocyanate, 4,4′-diphenyl-methane diisocyanate, 2,2′,5,5′-tetrachlorodiphenyl-4,4′-diisocyanate, and tolylene diisocyanate; hexamethylene diisocyanate; 2,5-bis(isocyanatomethyl)-1,4-dithiane; bis(isocyanatomethyl)sulfide; bis(isocyanatoethyl)sulfide; bis(isocyanatomethyl)disulfide; and bis(isocyanatoethyl)disulfide. Also, polyisocyanates containing at least one alicyclic ring can be used. Specific examples thereof include bis(isocyanatomethyl)cyclohexane, bis(4-isocyanato-cyclohexyl)methane, bis(4-isocyanatomethylcyclohexyl)methane, cyclohexane diisocyanate, isophorone diisocyanate, 2,5-bis(isocyanatomethyl)bicyclo[2.2.2]octane, 2,5-bis-(isocyanatomethyl)bicyclo[2.2.1]heptane, 2-isocyanatomethyl-3-(3-isocyanatopropyl)-5-isocyanatomethyl-bicyclo[2.2.1]-heptane, 2-isocyanatomethyl-3-(3-isocyanatopropyl)-6-isocyanatomethyl-bicyclo[2.2.1]heptane, 2-isocyanatomethyl-2-[3-isocyanatopropyl]-5-isocyanatomethyl-bicyclo[2.2.1]-heptane, 2-isocyanatomethyl-2-(3-isocyanato-propyl)-6-isocyanatomethyl-bicyclo[2.2.1]-heptane, 2-isocyanatomethyl-3-(3-isocyanatopropyl)-6-(2-isocyanatoethyl)-bicyclo[2.2.1]-heptane, 2-isocyanatomethyl-3-(3-isocyanatopropyl)-6-(2-isocyanatoethyl)-bicyclo[2.2.1]-heptane, 2-isocyanatomethyl-2-(3-isocyanatopropyl)-5-(2-isocyanatoethyl)-bicyclo[2.2.1]-heptane, 2-isocyanatomethyl-2-(3-isocyanatopropyl)-6-(2-isocyanatoethyl)-bicyclo[2.2.1]-heptane, and dicyclohexylmethane diisocyanate.

Of these polyisocyanate compounds, bis(isocyanatomethyl)-bicyclo[2.2.1]heptane, bis(isocyanatomethyl)cyclohexane, isophorone diisocyanate, dicyclohexylmethane diisocyanate, cyclohexane diisocyanate, and bis(isocyanatomethyl)-1,4-dithiane are preferable. Of these polyisocyanate compounds, for the sake of obtaining a lens having good refractive index and Abbe's number, an alicyclic ring or aromatic ring-containing polyisocyanate compound may be used.

Polyisocyanate compounds may be used singly or in admixture.

Examples of the polythiol compound (3) that is used in the invention include compounds containing or not containing a sulfur atom in addition to a mercapto group, such as methanedithiol, ethanedithiol, propanedithiol, 1,6-hexanedithiol, 1,2,3-trimercaptopropane, tetrakis(mercaptomethyl)methane, cyclohexanedithiol, 2,2-dimethylpropane-1,3-dithiol, 3,4-dimethoxybutane-1,2-dithiol, 2-methylcyclohexane-2,3-dithiol, bis(mercaptomethyl)cyclohexane, 2,3-dimercapto-1-propanol(2-mercaptoacetate), 2,3-dimercapto-1-propanol(3-mercaptoacetate), diethylene glycol bis(2-mercaptoacetate), diethylene glycol bis(3-mercaptopropionate), 1,2-dimercaptopropylmethyl ether, 2,3-dimercaptopropylmethyl ether, 2,2-bis(mercaptomethyl)-1,3-propanedithiol, bis(2-mercaptoethyl)ether, ethylene glycol bis(2-mercaptoacetate), ethylene glycol bis(3-mercaptopropionate), trimethylolpropane tris(2-mercaptoacetate), trimethylolpropane tris(3-mercapto-propionate), pentaerythritol tetrakis(2-mercaptoacetate), pentaerythritol tetrakis(3-mercaptopropionate), 1,2-bis(2-mercaptoethylthio)-3-mercaptopropane, bis(mercaptomethyl)sulfide, bis(mercaptoethyl)sulfide, bis(mercaptopropyl)sulfide, bis(mercaptomethylthio)methane, bis(2-mercapto-ethylthio)methane, bis(3-mercaptopropyl)methane, 1,2-bis(mercaptomethylthio)ethane, 1,2-(2-mercaptoethylthio)ethane, 1,2-(3-mercaptopropyl)ethane, 1,3-bis(mercaptomethylthio)propane, 1,3-bis(2-mercaptoethylthio)propane, 1,3-bis(3-mercaptopropylthio)propane, 1,2-bis(2-mercaptoethylthio)-3-mercaptopropane, 2-mercaptoethylthio-1,3-propanedithiol, 1,2,3-tris(mercaptomethylthio)propane, 1,2,3-tris(2-mercaptoethylthio)propane, 1,2,3-tris(3-mercaptopropylthio)propane, tetrakis-(mercaptomethylth iomethyl)methane, tetrakis(2-mercapto-ethylthiomethyl)methane, tetrakis(3-mercaptopropylthiomethyl)methane, bis(mercaptomethyl)disulfide, bis(mercaptoethyl)disulfide, bis(mercaptomethyl)-3,6,9-trithia-1,11-undecanedithiol, bis(1,3-dimercapto-2-propyl)sulfide, 3,4-thiophenedithiol, tetrahydrothiophene-2,5-dimercaptomethyl, 2,5-dimercapto-1,3,4-thiadiazole, 2,5-dimercapto-1,4-dithiane, 2,5-bis(mercaptomethyl)-1,4-dithiane, and 2,5-bis(mercaptoethyl)-1,4-dithiane.

Of these polythiol compounds, bis(mercaptomethyl)-1,4-dithiane, bis(mercaptoethyl)sulfide, bis(mercaptoethyl)disulfide, 1,2-bis(mercaptoethyl)-thio-3-mercaptopropane, pentaerythritol tetrakismercaptocatate, pentaerythritol tetrakismercaptopropionate, trimethylolpropane trismercaptoacaetate, trimethylolpropane trismercaptopropionate, and trimethylmercaptopropane are preferable.

Incidentally, polythiol compounds may be used singly or in admixture.

In the invention, a variety of additives such as an ultraviolet light absorber, an infrared light absorber, a light stabilizer, an internal releasing agent, an antioxidant, a dye, a photochromic dye, a pigment, and an antistatic agent may be added to the mixture of the foregoing prepolymer (1), polyisocyanate compound (2) and polythiol compound (3), thereby imparting specific effects to the resin.

Also, a catalyst may be added for the purpose of reacting the foregoing prepolymer (1), polyisocyanate compound (2) and polythiol compound (3). Examples of the catalyst include amines, phosphines, quaternary ammonium salts, quaternary phosphonium salts, tertiary sulfonium salts, secondary iodonium salts, mineral acids, Lewis acids, organic acids, silicic acids, and tetrafluoroboric acids.

Of these catalysts, amines such as aminoethanol, 1-aminopropanol, 2-aminopropanol, aminobutanol, aminopentanol, and aminohexanol; and quaternary phosphonium salts such as tetramethylphosphonium chloride, tetramethylphosphonium bromide, tetraethylphosphonium chloride, tetraethylphosphonium bromide, tetra-n-butylphosphonium chloride, tetra-n-butylphosphonium bromide, tetra-n-bu-tylphosphonium iodide, tetra-n-hexylphosphonium bromide, and tetra-n-octylphosphonium bromide are preferable.

Also, though it is required to select the catalyst to be used depending upon the kind of the monomer to be used and adjust its use amount, in general, the catalyst is used in an amount in the range of from 0.001% by weight to 0.1% by weight based on the whole amount of the lens raw materials.

A method of mixing these raw materials (1) to (3) is not particularly limited. In mixing, with respect to the setting temperature, the required time, and the like, conditions under which the respective components are sufficiently mixed may be basically employed. From the viewpoints that undesired reactions among the respective raw materials and the additives are suppressed and that the viscosity is not increased beyond the necessity, thereby making the casting operating easy, the mixing is carried out at a mixing temperature in the range of −30° C. to 50° C., or from −5° C. to 30° C. The mixing may be carried out for a mixing time in the range of from 5 minutes to 2 hours, or from about 5 minutes to 15 minutes.

Also, from the standpoint of preventing the generation of foams during the subsequent cast polymerization and curing, a degasification operation in vacuo before, during or after mixing of the respective raw materials and additives may be carried out. At this time, the degasification operation may be carried out under a degree of vacuum in the range of from about 0.1 mmHg to 50 mmHg or from 1 mmHg to 20 mmHg.

Further, from the standpoint of further enhancing the quality of the optical material of the invention it may be desirable to purify the mixture or the major and subsidiary raw materials before mixing by filtration with a filter having a pore size of from about 0.2 to 20 μm.

The mixed raw materials and the like are poured into a glass or metal-made die and polymerized and cured in an electric furnace or the like. The curing temperature may be from 5° C. to 120° C. and the curing time is usually from 1 to 72 hours. Also, after completion of the curing, a desirable treatment for removing a deformation of the plastic lens of the invention is to anneal the material at a temperature of from 50 to 150° C. for from about 10 minutes to 5 hours.

In the case where the plastic lens obtained by the production process of the invention is hardly separated from the die after the polymerization, a known external and/or internal releasing agent may be used or added, thereby enhancing release properties. Also, for the purpose of protecting the resin or eyes from ultraviolet light, a ultraviolet light absorber may be added, and for the purpose of protecting eyes from infrared light, an infrared light absorber may be added. The addition amount thereof may vary depending upon the absorption ability and maximum absorption wavelength of an additive to be used but is approximately from about 0.03% by weight to 3% by weight. Also, a method of impregnating the resin with such an absorber later may be employed.

Further, for the purpose of keeping or enhancing the appearance of the resin, the resin may be subjected to bluing by adding an antioxidant or using a trace amount of blue and red dyes or pigments.

The plastic lens obtained in the invention can be subjected to dyeing treatment using a dye. Also, for the sake of enhancing scratch resistance, a cured coating film may be formed on the plastic lens using a coating liquid containing an organosilicon compound or an acrylic compound and finely divided inorganic materials such as tin oxide, silicon oxide, zirconium oxide, and titanium oxide. Above all, a cured coating film using an organosilicon compound is preferable because a further excellent effect is obtained.

Also, for the sake of enhancing the impact resistance, a primer layer containing a polyurethane as the major component may be formed between the plastic lens and the foregoing cured coating film.

Further, for the sake of imparting an antireflection performance, an antireflection film made of an inorganic substance such as silicon oxide, titanium dioxide, zirconium oxide, and tantalum oxide may be formed on the foregoing cured coating film. Also, for the sake of enhancing water repellency, a water repellent film made of a fluorine atom-containing organosilicon compound may be formed on the foregoing antireflection film.

The thus obtained plastic lens of the invention preferably has a refractive index of from 1.69 to 1.72.

Also, the plastic lens of the invention preferably has an Abbe's number of 32 or more, and more preferably 35 or more.

Further, the resulting plastic lens is less in coloration, high in transparency and high in mechanical strength.

Also, in addition to the plastic lens obtained by the foregoing method, the invention includes a plastic lens having transparency, which is comprised of a prepolymer obtained by reacting a polyisocyanate compound, a polythiol compound, an epithio group-containing compound, and sulfur. What the plastic lens has transparency means that the plastic lens has the same or substantially the same transparency as compared with the case of producing lenses having the same thickness without using sulfur but using the similar raw materials.

In the invention, the transparency of the plastic lens is defined as a transmission coefficient, Σ=Φₑₓ/φᵢₙ, wherein φₑₓ represents an intensity of light transmitted through the lens upon exposure with visible light (wavelength: from 400 to 750 nm), and φᵢₙ represents an intensity of visible light incident into the lens.

In the case where an antireflection film is not coated, the value of transparency of the lens relies upon the value of the refractive index of the lens. This is because a lens giving a high refractive index gives a high reflection value.

In the invention, when the plastic lens having a refractive index of from 1.55 to 1.65 is measured in a thickness of 1.8 mm using a wavelength of from 500 nm to 600 nm, it preferably has a transparency in the range of from 0.80 to 0.92, more preferably from 0.85 to 0.92, and especially preferably from 0.88 to 0.92.

Also, when the plastic lens having a refractive index of from 1.66 to 1.72 is measured in a thickness of 1.8 mm using a wavelength of from 500 nm to 600 nm, it preferably has a transparency in the range of from 0.80 to 0.91, more preferably from 0.85 to 0.91, and especially preferably from 0.88 to 0.92.

### EXAMPLES

The invention will be described below in more detail with reference to the following Examples, but it should not be construed that the invention is limited to these Examples. Incidentally, physical properties of plastics lenses obtained in the Examples and Comparative Examples were evaluated in the following manners.

(1) Refractive index and Abbe's number:

The measurement was carried out at 20° C. using a precision refractometer KPR-200 Model, manufactured by Kalnew Optical Industrial Co., Ltd. In Table 1, nd is a refractive index at 587.6 nm; ne is a refractive index at 546.1 nm; an Abbe's number vd is a value of (nd−1)/(nF−nC); and an Abbe's number νe is a value of (ne−1)/(nF′−nC′), wherein nC is a refractive index at 656.3 nm; nF is a refractive index at 486.1 nm; nC′ is a refractive index at 643.9 nm; and nF′ is a refractive index at 480.0 nm.

(2) Heat resistance:

The measurement was carried out using a thermal analyzer TAS-100, TMA8140, manufactured by Regaku Corporation by the penetration method (sample thickness: 3 mm, pin diameter: 0.5 mm, load 10 g, temperature-rising rate: 10° C./min), and a temperature of a peak value at which thermal expansion changed was measured. In Table 1, this is designated as Tg.

(3) Tensile strength:

[056] A lens adjusted so as to have 0.00 D, a lens diameter of 80 mm and a thickness of 1.8 mm was processed into one for lens frame and bored holes having a diameter of 1.6 mm at two positions using a drill on the assumption of two-point spectacle frame processing, to prepare a sample. A shaft having a diameter of 1.6 mm was penetrated into each of the holes, the both ends of the sample were fixed and drawn at a rate of 5 mm/min using a tensilon universal testing machine (model: RTC-1225A), manufactured by A&D Company, Ltd., and a strength at the time of causing breakage was measured.

(4) Transparency:

The appearance of the produced plastic lens was visually observed.

### Example 1

(a) Production of Prepolymer (Whole Amount of Prepolymer: 211.6 Parts by Weight):

In a flask, 200 parts by weight of bis(β-epithiopropyl)sulfide as an epithio group-containing compound and 10 parts by weight of sulfur (manufactured by Wako Pure Chemical Industries, Ltd., flower of sulfur, purity: 99% by weight) were charged based on the whole amount of the raw materials, and the mixture was heated for dissolution at 55° C. 1.6 parts by weight of methimazole (2-mercapto-N-methylimidazole) as a vulcanization accelerator was added to the solution, and the mixture was allowed to react for 5 hours, followed by cooling to 25° C. to produce a prepolymer. The resulting prepolymer had a refractive index (nd) of 1.623 (at 60° C.).

(b) Production of Plastic Lens:

10.71 parts by weight of bis(isocyanatomethyl)bicyclo-[2.2.1]heptane as a polyisocyanate compound was weighed and charged in a flask, to which were then added 0.35 parts by weight of SEESORB 707, manufactured by Shipro Kasei Kaisha, Ltd. as a ultraviolet light absorber, 0.004 parts by weight of an acidic phosphoric acid ester (JP-506H, manufactured by Johoku Chemical Co., Ltd.) as an internal releasing agent, 0.04 parts by weight of tetrabutylphosphonium bromide as a curing catalyst, and 200 ppb, based on the whole amount of the raw materials, a blend of a trade name, Diaresin Blue G (manufactured by Mitsubishi Chemical Corporation) and a trade name, Diaresin Red HS (manufactured by Mitsubishi Chemical Corporation) as a bluing agent in a weight proportion of blue to red of 7/3, and the mixture was stirred and dissolved.

After dissolution, 19.29 parts by weight of bis(mercaptomethyl)-1,4-dithiane as a polythiol compound was added, and the mixture was stirred such that it became uniform. Thereafter, 70 parts by weight of the prepolymer produced above in (a) was added, and the mixture was further stirred. When the mixture became substantially uniform, the resulting mixture was subjected to degasification in vacuo of 4,000 Pa while stirring for 10 minutes and filtered by a Teflon filter having a pore size of 1 μm (Teflon is a trade mark), and the filtrate was poured into a molding die composed of a glass mold and a gasket.

This poured molding die was subjected to temperature rising step by step from 20° C. to 100° C. over 22 hours and held at 100° C. for one hour, thereby performing polymerization. With respect to the polymerization posture, a posture in which the lens convex is positioned upward, and the molding die is inclined at about 15° against the horizontal plane, thereby sending air bubbles having incorporated at the time of pouring way into the edge may be employed. Also, taking into account polymerization striae, the polymerization may be carried out in the horizontal posture. After completion of the polymerization, the resin was gradually cooled and then taken out from the die. For the sake of reducing the deformation formed in the resulting resin and stabilizing the power of lens, the resin was annealed such that after heating at 105° C. for one hour, the temperature was gradually cooled from the glass transition temperature to 20° C. There was thus obtained a plastic lens.

With respect to the thus obtained plastic lens, the foregoing physical properties (1) to (4) were measured and evaluated, the results of which are shown in Table 1.

As shown in Table 1, the resulting plastic lens was a lens having high transparency and having excellent refractive index, Abbe's number, heat resistance and mechanical strength.

### Examples 2 to 13

Plastic lenses were produced in the same manner as in Example 1 under the conditions of the respective raw materials and amounts shown in Table 1, except for the matter of addition or non-addition of the bluing agent. Then, the foregoing physical properties (1) to (4) were measured and evaluated, the results of which are shown in Table 1. Likewise the lens obtained in Example 1, the resulting lenses were a lens having high transparency and having excellent refractive index, Abbe's number, heat resistance and mechanical strength.

### Example 14

(c) Production of Prepolymer (Whole Amount of Prepolymer: 211.6 Parts by Weight):

In a flask, 160 parts by weight of bis(β-epithiopropyl)sulfide and 40 parts by weight of bis(β-epithiopropyl)disulfide as epithio group-containing compounds and 10 parts by weight of sulfur (manufactured by Wako Pure Chemical Industries, Ltd., flower of sulfur, purity: 99% by weight) were charged based on the whole amount of the raw materials, and the mixture was heated for dissolution at 55° C. 1.6 parts by weight of methimazole (2-mer-capto-N-methylimidazole) as a vulcanization accelerator was added to the solution, and the mixture was allowed to react for 5 hours, followed by cooling to 25° C. to produce a prepolymer. The resulting prepolymer had a refractive index (nd) of 1.634 (at 60° C.).

With respect to the production step of a plastic lens, a plastic lens was produced in the same manner as in Example 1, except for using 70 parts by weight of the prepolymer prepared above in (c) under the conditions of the respective raw materials and amounts shown in Table 1 and changing the addition amount of the bluing agent to 600 ppb.

### Comparative Example 1

An epithio group-containing compound and sulfur were dissolved, but prepolymerization did not occur. A polyisocyanate compound and a polythiol compound were added to this mixed solution to produce a plastic lens. That is, the plastic lens was produced in the following manner.

In a flask, 66.16 parts by weight of bis(β-epithiopropyl)sulfide and 3.31 parts by weight of sulfur (manufactured by Wako Pure Chemical Industries, Ltd., flower of sulfur, purity: 99% by weight) were charged based on the whole amount of the raw materials, and the mixture was heated for dissolution at 55° C. for from about 15 to 30 minutes. Immediately thereafter, 0.53 parts by weight of methimazole was added and dissolved, and immediately thereafter, the mixture was cooled to 25° C. This is designated as “solution 1”.

10.71 parts by weight of bis(isocyanatomethyl)bicyclo-[2.2.1]heptane as a polyisocyanate compound, 0.35 parts by weight of SEESORB 707, manufactured by Shipro Kasei Kaisha, Ltd. as a ultraviolet light absorber, 0.004 parts by weight of an acidic phosphoric acid ester (JP-506H, manufactured by Johoku Chemical Co., Ltd.) as an internal releasing agent, and 0.04 parts by weight of tetrabutylphosphonium bromide as a curing catalyst were added, and the mixture was stirred and dissolved.

After dissolution, 19.29 parts by weight of bis(mercaptomethyl)-1,4-dithiane as a polythiol compound was added, and the mixture was further uniformly dissolved. Next, 70 parts by weight of the solution 1 was added, and the mixture was substantially uniformly mixed. The resulting mixture was subjected to degasification in vacuo of 4,000 Pa while stirring for 10 minutes and filtered by a Teflon filter having a pore size of 1 μm (Teflon is a trade mark), and the filtrate was poured into a molding die composed of a glass mold and a gasket.

This poured molding die was subjected to temperature rising step by step from 25° C. to 100° C. over 22 hours and held at 100° C. for one hour, thereby performing polymerization. After completion of the polymerization, the resin was gradually cooled and then taken out from the die. The resulting resin was cloudy and failed in transparency. The results are shown in Table 1.

### Comparative Example 2

The same procedures as in Comparative Example 1 were followed, except that the amount of bis(isocyanatomethyl)bicyclo[2.2.1]heptane was changed to 13.12 parts by weight and that the amount of bis(mercaptomethyl)-1,4-dithiane was changed to 16.88 parts by weight. The resulting resin was cloudy and failed in transparency. The results are shown in Table 1.

### Comparative Example 3

A plastic lens was produced without using sulfur and a polyisocyanate compound. That is, the plastic lens was produced in the following manner.

In a flask, 95 parts by weight of bis(β-epithiopropyl)sulfide as an epithio group-containg compound, 0.35 parts by weight of SEESORB 707, manufactured by Shipro Kasei Kaisha, Ltd. as a ultraviolet light absorber, and 0.04 parts by weight of tetrabutylphosphonium bromide as a curing catalyst were added, and the mixture was stirred and dissolved.

After dissolution, 5.00 parts by weight of bis(mercaptomethyl)-1,4-dithiane as a polythiol compound was added, and the mixture was substantially uniformly mixed. The resulting mixture was subjected to degasification in vacuo of 4,000 Pa while stirring for 10 minutes and filtered by a Teflon filter having a pore size of 1 μm (Teflon is a trade mark), and the filtrate was poured into a molding die composed of a glass mold and a gasket.

This poured molding die was subjected to temperature rising step by step from 25° C. to 100° C. over 22 hours and held at 100° C. for one hour, thereby performing polymerization. After completion of the polymerization, the resin was gradually cooled and then taken out from the die.

The resulting resin was colorless and transparent and excellent in optical characteristics, the tensile strength of which was, however, low as 28 kgf.

TABLE 1

| | Epithio compound + Sulfur Prepolymer | | | Polyisocyanate compound | Polythiol compound |
|---|---|---|---|---|---|
| Example 1 | [(EPS + Sulfur) + Vulcanization | | | NBDI: 10.71 parts by weight | DMMD: 19.29 parts by weight |
| Example 2 | catalyst:mz]: 70 parts by weight | | | NBDI: 11.79 parts by weight | DMMD: 18.21 parts by weight |
| Example 3 | | | | NBDI: 13.12 parts by weight | DMMD: 16.88 parts by weight |
| Example 4 | | | | HXDI: 10.29 parts by weight | DMMD: 19.71 parts by weight |
| Example 5 | | | | HXDI: 11.37 parts by weight | DMMD: 18.63 parts by weight |
| Example 6 | | | | HXDI: 12.69 parts by weight | DMMD: 17.31 parts by weight |
| Example 7 | | | | BIMD: 12.59 parts by weight | DNND: 17.41 parts by weight |
| Example 8 | | | | XDI: 11.15 parts by weight | DMMD: 18.86 parts by weight |
| Example 9 | | | | CHDI: 10.29 parts by weight | DMMD: 19.71 parts by weight |
| Example 10 | | | | NBDI: 12.13 parts by weight | DMETMP: 17.87 parts by weight |
| Example 11 | | | | NBDI: 13.26 parts by weight | DMETMP: 16.74 parts by weight |
| Example 12 | | | | NBDI: 14.62 parts by weight | DMETMP: 15.38 parts by weight |
| Example 13 | | | | HXDI: 12.83 parts by weight | DMETMP: 17.17 parts by weight |
| Example 14 | [EPS + EPDS + Sulfur) + | | | NBDI: 11.79 parts by weight | DMMD: 18.21 parts by weight |
| | Vulcanization catalyst:mz]: 70 parts | | | | |
| | by weight (EPS:EPDS = 4:1) | | | | |
| Comparative | EPS: 66.16 parts | S: 3.31 parts | mz: 0.53 parts | NBDI: 10.71 parts by weight | DMMD: 19.29 parts by weight |
| Example 1 | by weight | by weight | by weight | | |
| Comparative | | | | NBDI: 13.12 parts by weight | DMMD: 16.88 parts by weight |
| Example 2 | | | | | |
| Comparative | EPS: 95.00 parts | | | — | DMMD: 5.00 parts by weight |
| Example 3 | by weight | | | | |

| | SH/NCO (molar ratio) | Additive | Others | nd | νd |
|---|---|---|---|---|---|
| Example 1 | 1.75/1.0 | Ultraviolet light absorber: 0.35 parts by weight | Bluing agent: 200 ppb | 1.69 | 36 |
| Example 2 | 1.5/1.0 | Internal releasing agent: 0.004 parts by weight | — | 1.69 | 36 |
| Example 3 | 1.25/1.0 | Curing catalyst: 0.04 parts by weight | — | 1.69 | 36 |
| Example 4 | 1.75/1.0 | | Bluing agent: 200 ppb | 1.69 | 35 |
| Example 5 | 1.5/1.0 | | — | 1.69 | 35 |
| Example 6 | 1.25/1.0 | | — | 1.69 | 36 |
| Example 7 | 1.5/1.0 | | — | 1.70 | 35 |
| Example 8 | 1.5/1.0 | | — | 1.70 | 34 |
| Example 9 | 1.5/1.0 | | — | 1.70 | 35 |
| Example 10 | 1.75/1.0 | | — | 1.69 | 35 |
| Example 11 | 1.5/1.0 | | — | 1.69 | 35 |
| Example 12 | 1.25/1.0 | | — | 1.69 | 35 |
| Example 13 | 1.5/1.0 | | — | 1.69 | 35 |
| Example 14 | 1.5/1.0 | | Bluing agent: 600 ppb | 1.71 | 34 |
| Comparative | 1.75/1.0 | Ultraviolet light absorber: 0.35 parts by weight | — | — | — |
| Example 1 | | Internal releasing agent: 0.004 parts by weight | | | |
| Comparative | 1.25/1.0 | Curing catalyst: 0.04 parts by weight | — | — | — |
| Example 2 | | | | | |
| Comparative | — | Ultraviolet light absorber: 0.35 parts by weight | — | 1.70 | 35 |
| Example 3 | | Curing catalyst: 0.04 parts by weight | | | |

| | ne | νe | Tg | Tensile strength | Appearance |
|---|---|---|---|---|---|
| Example 1 | 1.70 | 35 | 86° C. | 58 kgf | Colorless and transparent |
| Example 2 | 1.69 | 35 | 95° C. | 61 kgf | Pale yellow and transparent |
| Example 3 | 1.69 | 35 | 106° C. | 44 kgf | Pale yellow and transparent |
| Example 4 | 1.70 | 35 | 85° C. | 56 kgf | Colorless and transparent |
| Example 5 | 1.69 | 35 | 93° C. | 55 kgf | Pale yellow and transparent |
| Example 6 | 1.69 | 35 | 100° C. | 47 kgf | Pale yellow and transparent |
| Example 7 | 1.71 | 34 | 92° C. | 48 kgf | Pale yellow and transparent |
| Example 8 | 1.71 | 34 | 81° C. | 61 kgf | Pale yellow and transparent |
| Example 9 | 1.70 | 35 | 102° C. | 45 kgf | Pale yellow and transparent |
| Example 10 | 1.70 | 35 | 81° C. | 55 kgf | Pale yellow and transparent |
| Example 11 | 1.69 | 35 | 86° C. | 54 kgf | Pale yellow and transparent |
| Example 12 | 1.69 | 35 | 106° C. | 50 kgf | Pale yellow and transparent |
| Example 13 | 1.69 | 35 | 85° C. | 55 kgf | Pale yellow and transparent |
| Example 14 | 1.70 | 34 | 93° C. | 58 kgf | Pale yellow and transparent |
| Comparative | — | — | — | — | Cloudy and opaque |
| Example 1 | | | | | |
| Comparative | — | — | — | — | Cloudy and opaque |
| Example 2 | | | | | |
| Comparative | 1.71 | 35 | — | 28 kgf | Colorless and transparent |
| Example 3 | | | | | |

EPS: Bis(β-epithiopropyl)sulfide
EPDS: Bis(β-epithiopropyl)disulfide
mz: 2-Mercapto-N-methylimidazole
NBDI: Bis(isocyanatomethyl)bicyclo[2.2.1]heptane
HXDI: Bis(isocyanatomethyl)cyclohexane
BIMD: Bis(isocyanatomethyl)-1,4-dithiane
CHDI: Cyclohexane diisocyanate
XDI: m-Xylylene diisocyanate
DMMD: Bis(mercaptomethyl)-1,4-dithiane
DMETMP: 1,2-Bis(mercaptoethylthio)-3-mercaptopropane

While the invention has been described in connection with certain embodiments so that aspects thereof may be more fully understood and appreciated, it is not intended to limit the invention to these particular embodiments. On the contrary, it is intended to cover all alternatives, modifications and equivalents as may be included within the scope of the invention as defined by the appended claims.

### Industrial Applicability

According to the production process of the invention, a plastic lens having a high refractive index, a high Abbe's number and a high mechanical strength is obtained. Also, the obtained plastic lens is suitable for spectacle plastic lenses.

1. A process of producing a plastic lens comprising polymerizing a mixture of (1) a prepolymer obtained by mixing sulfur of 0.1% by weight to 10% by weight based on the whole amount of the mixture and an epithio group-containing compound and by reacting the sulfur and the epithio group-containing compound, (2) a polyisocyanate compound, and (3) a polythiol compound.

2. The process of producing a plastic lens according to claim 1, wherein a proportion of the polyisocyanate compound to the polythiol compound is 1.0 or more in terms of a molar ratio of —SH group/-NCO group.

3. The process of producing a plastic lens according to claim 1, wherein the total sum of the polyisocyanate compound and the polythiol compound is from 3% by weight to 50% by weight based on the whole amount of the mixture.

4. The process of producing a plastic lens according to any one of claims 1 to 3, wherein the polyisocyanate compound is an alicyclic ring or aromatic ring-containing compound.

5. The process of producing a plastic lens according to any one of claims 1 to 3, wherein the polyisocyanate compound is at least one member selected from bis(isocyanatomethyl)bicyclo[2.2.1]heptane, bis(isocyanatomethyl)cyclohexane, isophorone diisocyanate, dicyclohexylmethane diisocyanate, cyclohexane diisocyanate, xylylene diisocyanate, and bis(isocyanatomethyl)-1,4-dithiane.

6. The process of producing a plastic lens according to any one of claims 1 to 3, wherein the epithio group-containing compound is at least one member selected from bis(β-epithiopropyl)sulfide, bis(β-epithiopropyl)disulfide, bis(β-epithiopropyl)ether, bis(β-epithiopropyl)methane, 1,2-bis(β-epithiopropyl)ethane, 1,3-bis(β-epithiopropyl)-propane, 2,5-bis(β-epithiopropyl)-1,4-dithiane, 1,3- and 1,4-bis(β-epithiopropyl)cyclohexanes, 1,3- and 1,4-bis(β-epithiopropyl)benzenes, bis[4-(β-epithiopropylthio)phenyl]sulfide, and [4-(β-epithiopropylthio)cyclohexyl]sulfide.

7. The process of producing a plastic lens according to any one of claims 1 to 3, wherein the polythiol compound is at least one member selected from bis(mercaptomethyl)-1,4-dithiane, bis(mercaptoethyl)sulfide, bis(mercaptoethyl)disulfide, 1,2-bis(mercaptoethyl)thio-3-mercaptopropane, pentaeryth-ritol tetrakismeracptoacetate, pentaerythritol tetrakismercaptopropionate, trimethylolpropane trismercaptoacetate, trimethylolpropane trismercaptopropionate, and trimercaptopropane.

8. The process of producing a plastic lens according to any one of claims 1 to 3, wherein the polyisocyanate compound is at least one member selected from bis(isocyanatomethyl)bicyclo[2.2.1]heptane, bis(isocyanatomethyl)cyclohexane, isophorone diisocyanate, dicyclohexylmethane diisocyanate, cyclohexane diisocyanate, xylylene diisocyanate, and bis(isocyanatomethyl)-1,4-dithiane;
wherein the epithio group-containing compound is at least one member selected from bis(β-epithiopropyl)sulfide, bis(β-epithiopropyl)disulfide, bis(β-epithiopropyl)ether, bis(β-epithiopropyl)methane, 1,2-bis(β-epithiopropyl)ethane, 1,3-bis(β-epithiopropyl)-propane, 2,5-bis(β-epithiopropyl)-1,4-dithiane, 1,3- and 1,4-bis(β-epithiopropyl)cyclohexanes, 1,3- and 1,4-bis(β-epithiopropyl)benzenes, bis[4-(β-epithiopropylthio)phenyl]sulfide, and [4-(β-epithiopropylthio)cyclohexyl]sulfide; and
wherein the polythiol compound is at least one member selected from bis(mercaptomethyl)-1,4-dithiane, bis(mercaptoethyl)sulfide, bis(mercaptoethyl)disulfide, 1,2-bis(mercaptoethyl)thio-3-mercaptopropane, pentaeryth-ritol tetrakismeracptoacetate, pentaerythritol tetrakismercaptopropionate, trimethylolpropane trismercaptoacetate, trimethylolpropane trismercaptopropionate, and trimercaptopropane.

9. The process of producing a plastic lens according to any one of claims 1 to 3, wherein the sulfur is one from which impurities having a boiling point of not higher than 120° C. are eliminated and which has a purity of 98% by weight or more.

10. The process of producing a plastic lens according to any one of claims 1 to 3, wherein the plastic lens has a refractive index of from 1.69 to 1.72.

11. The process of producing a plastic lens according to any one of claims 1 to 3, further comprising a step of forming a cured coating film on the plastic lens.

12. The process of producing a plastic lens according to claim 11, wherein a raw material of the cured coating film is an organosilicon compound.

13. The process of producing a plastic lens according to claim 11, further comprising a step of forming a primer layer between the plastic lens and the cured coating film.

14. The process of producing a plastic lens according to claim 11, further comprising a step of forming an antireflection film made of an inorganic substance on the cured coating film.

15. The process of producing a plastic lens according to claim 14, further comprising including a step of forming a water repellent film made of a fluorine atom-containing organosilicon compound on the antireflection film.

16. A plastic lens obtained by the process according to any one of claims 1 to 3.

17. A plastic lens obtained by the process of claim 5.

18. A plastic lens obtained by the process of claim 6.

19. A plastic lens obtained by the process of claim 7.

20. A plastic lens obtained by the process of claim 8.
